(19) United States
(12) Patent Application Publication
(10) Pub. No.: US 2015/0363842 A1
(43) Pub. Date: Dec. 17, 2015

(54) PRICE-COMPETITIVENESS ANALYSIS

(71) Applicant: Google Inc., Mountain View, CA (US)

(72) Inventor: NEIL HOYNE, Santa Clara, CA (US)

(73) Assignee: Google Inc., Mountain View, CA (US)

(21) Appl. No.: 14/215,842

(22) Filed: Mar. 17, 2014

(51) Int. Cl. G06Q 30/02

(52) U.S. Cl. CPC G06Q 30/0283

(57) ABSTRACT

Systems, methods, and computer-readable storage media that may be used to analyze user path data and determine price-competitiveness of offers reflected therein are provided. One method includes receiving user path data representing a plurality of user paths, each including one or more sales interactions in which a user was presented with an offer to purchase an item at an offer price. One or more user paths include conversion events in which the user purchases the item. The method further includes receiving competitive price data indicating one or more prices at which the item was offered for sale by one or more third party entities and determining a price-competitiveness metric for at least one of the sales interactions based on a comparison of the offer price with the competitive price data. The method further includes providing data based on the price-competitiveness metric to the content provider.

### BACKGROUND

Content management systems may present content items to users (e.g., by selecting the content items using auction processes) that market one or more products/services of a content provider. In some implementations, a content item may be displayed that markets a particular product to users, and if a user clicks on or otherwise selects the content item, the user may be directed to a resource (e.g., a webpage) through which the user may purchase the product. The user may purchase the product, or may navigate away from the resource.

Analysis systems may be configured to analyze results of user interactions and provide one or more metrics to the content provider relating to the interactions. Analysis systems may capture information such as the content channel, the particular content item, the content campaign, placement position, and/or other characteristics associated with one or more user interactions leading to a resource through which a product/service is offered for sale. However, such analysis systems do not consider the impact of the price offered by the content provider on the likelihood the user will convert (e.g., the likelihood the user will click through a content item leading to the resource and purchase the product/service through the resource).

### SUMMARY

One illustrative implementation of the disclosure relates to a method that includes receiving, at a computerized analysis system, user path data representing a plurality of user paths, each including one or more content interactions in which a user was presented with a content item featuring information relating to an item available for purchase and one or more sales interactions in which a user was presented with an offer to purchase an item at an offer price. The item is at least one of a product or service offered by a content provider, and one or more of the plurality of user paths includes conversion events in which the user purchases the item. The method further includes receiving, at the analysis system, competitive price data indicating one or more prices at which the item was offered for sale by one or more third party entities. The method further includes determining, by the analysis system, a price-competitiveness metric for at least one of the one or more sales interactions based on a comparison of the offer price with the competitive price data. The method further includes providing data based on the price-competitiveness metric to the content provider.

Another implementation relates to a system including at least one computing device operably coupled to at least one memory. The at least one computing device is configured to receive user path data representing a plurality of user paths, each including one or more content interactions in which a user was presented with a content item featuring information relating to an item available for purchase and one or more sales interactions in which a user was presented with an offer to purchase an item at an offer price. The item is at least one of a product or service offered by a content provider, and one or more of the plurality of user paths includes conversion events in which the user purchases the item. The at least one computing device is further configured to receive competitive price data indicating one or more prices at which the item was offered for sale by one or more third party entities and to determine a price-competitiveness metric for at least one of the one or more sales interactions based on a comparison of the offer price with the competitive price data. The at least one computing device is further configured to provide data based on the price-competitiveness metric to the content provider.

Yet another implementation relates to one or more computer-readable storage media having instructions stored thereon that, when executed by at least one processor, cause the at least one processor to perform operations. The operations include receiving user path data representing a plurality of user paths, each including one or more content interactions in which a user was presented with a content item featuring information relating to an item available for purchase and one or more sales interactions in which a user was presented with an offer to purchase an item at an offer price. The item is at least one of a product or service offered by a content provider, and one or more of the plurality of user paths includes conversion events in which the user purchases the item. The operations further include receiving competitive price data indicating one or more prices at which the item was offered for sale by one or more third party entities and determining a price-competitiveness metric for at least one of the one or more sales interactions based on a comparison of the offer price with the competitive price data. The price-competitiveness metric provides a quantitative indication of a relative competitiveness of the offer price with respect to one or more competitor offer prices for the item offered by the one or more third party entities. The operations further include providing data based on the price-competitiveness metric to the content provider.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for determining the price-competitiveness of one or more item offers presented to users according to an illustrative implementation.

FIG. 3 is a flow diagram of a process for determining characteristics indicative of price-sensitivity of users according to an illustrative implementation.

FIG. 4 is an illustration of a user interface configured to present a plurality of item-level price-competitiveness metrics according to an illustrative implementation.

FIG. 5 is an illustration of a user interface configured to present a conversion rate report according to an illustrative implementation.

FIG. 6 is an illustration of a user interface configured to present a user path report according to an illustrative implementation.

FIG. 7 is an illustration of a user interface configured to present an aggregate business report according to an illustrative implementation.

FIG. 8 is a block diagram of a computing system according to an illustrative implementation.

### DETAILED DESCRIPTION

Referring generally to the Figures, various illustrative systems and methods are provided that provide information about the price-competitiveness of prices at which a content provider has offered items for sale to users. In some implementations, the systems and methods may provide information about the relationship between how often users convert (e.g., purchase a product/service) and/or abandon (e.g., navigate away from the resource and do not return) and the competitiveness of the price offered to the users. An analysis system may receive user path data representing multiple user paths, each including one or more user interactions. Each user path may include one or more sales offer interactions with resources through which the user is offered the opportunity to purchase a product/service for a specified price. Each sales offer interaction may result in a conversion (e.g., the user purchases the product/service at the specified price), an abandonment (e.g., the user navigates away from the resource with which the sales offer interaction occurs and makes no further interactions with associated resources of the content provider), or one or more subsequent interactions (e.g., the user navigates away from the resource, but later returns to the resource or a related resource, which may in turn result in a conversion, an abandonment, or further interactions).

For at least some of the sales offer interactions (e.g., all of the sales offer interactions, sales offer interactions associated with conversions and abandonments, etc.), the analysis system may determine a sales offer price associated with the sales offer interaction and a reference competitor price offered by other parties for the product/service. In some implementations, the analysis system may be configured to determine the competitive price based on pricing data for the product/service received from a shopping system configured to offer products and/or services sold by multiple parties. The analysis system may receive one or more sales prices for the product/service offered by other parties, and may determine the reference competitor price based on the received sales prices (e.g., an average or mean of the received sales prices). The analysis system may determine a competitiveness of the sales offer price for a sales offer interaction by comparing the sales offer price to the reference competitor price.

The analysis system may be configured to provide price-competitiveness indications to the content provider in one or more of a variety of ways. In some implementations, the analysis system may generate an item-level report that provides aggregated (e.g., averaged) price-competitiveness data of a product/service across the user paths. In some implementations, a price-competitiveness score may be a relative indication of how competitive the sales offer prices were (e.g., on average) in comparison to the reference competitor price (e.g., much lower, slightly lower, about the same, slightly higher, much higher, etc.). In some implementations, the indication may additionally or alternatively provide some level of detail about the relationship between the sales offer prices and the reference competitor prices, such as an average price difference between the prices. In some implementations, the system may provide an indication of the relationship between the price-competitiveness of the sales offer price and the likelihood that the user would convert, abandon, and/or not convert but return for future interactions.

In some implementations, the system may provide detailed competitiveness data for one or more individual sales offer interactions. In some illustrative implementations, the system may provide a representation of one or more of the sales offer interactions including an indication of the price-competitiveness of the price associated with the interaction. In some implementations, the system may also provide an indication of whether the sales offer interaction resulted in a conversion.

In some implementations, the system may generate an aggregated business report based on the price-competitiveness data. In some such implementations, the system may aggregate the price-competitiveness data across multiple sets of user path data for the content provider to generate an overall indication of the price-competitiveness of the provider across its products/services. In some implementations, the system may identify one or more trends within the data, such as days and/or times during which the content provider tends to be more or less price-competitive.

In some implementations, the system may combine the price-competitiveness data with other available data to infer one or more conclusions relating to the sales offer prices. In some such implementations, the system may combine the price-competitiveness data with one or more aggregated characteristics of the users to whom the offers were presented. The combined data may be used to infer characteristics of users who are more or less likely to be sensitive to the price-competitiveness of presented offers. For instance, if a particular common characteristic was found to be present for users who converted at a high rate despite sales offer prices being uncompetitive, that characteristic may be determined to be associated with users who are relatively insensitive to price. If a characteristic was found to be present for users who converted at a significantly lower rate when the sales offer prices were uncompetitive (e.g., as compared to when the sales offer prices were competitive), that characteristic may be determined to be associated with users who are price-sensitive.

In some implementations, the system may take one or more actions based on the price-competitiveness data. In some such implementations, the system may utilize the price-competitiveness data to determine adjustments to make to future bids to present content items to users. In one illustrative implementation, if available user characteristics indicate a likelihood that the user may be price-sensitive, a bid adjustment may be made to lower a bid in an auction to present a content item to the user. If available user characteristics indicate a likelihood that the user is not price-sensitive, a bid adjustment may be made to increase a bid in the auction to improve the chance the associated content item will be presented to the user.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

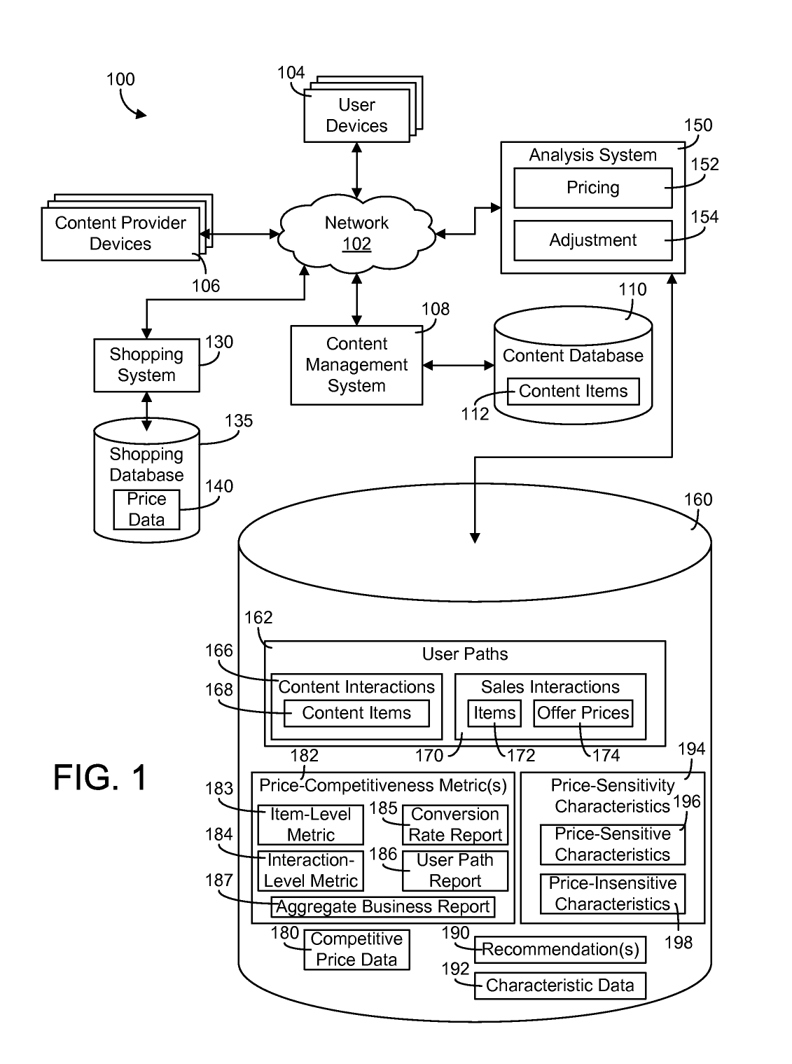

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

Some of the content published by system 108 may be configured to market one or more items (e.g., product/services) and/or brands to users. In some implementations, a user may click on or otherwise select a content item, and may be presented with a resource (e.g., webpage) through which the user may purchase the item being promoted at an offer price offered by the content provider.

An analysis system 150 may be configured to analyze user path data relating to interactions of one or more users of user devices 104 and evaluate the price-competitiveness of offers made to the users to purchase products/services. In some implementations, analysis system 150 may receive path data 162 that includes multiple user paths. Each user path represents one or more interactions of a user with one or more resources (e.g., webpages, applications, etc.) and/or content items (e.g., paid and/or unpaid content items displayed within a resource, such as items displayed within a search engine results interface). At least some of the user paths include sales interactions 170 in which a user is presented with an offer to purchase an item 172 (e.g., a product and/or service) at an offer price 174. System 150 may obtain competitive price data 180 for one or more third party entities (e.g., competitors) and determine one or more price-competitiveness metrics 182 indicative of how competitive one or more offer prices 174 were in relation to prices offered for the item by the third parties. In various implementations, price-competitiveness metrics 182 may be organized and/or presented in a variety of different formats configured to provide different types of price-competitiveness information to a content provider. In some implementations, system 150 may determine characteristics indicative of whether a user is likely to be price-sensitive, and may suggest and/or implement one or more bid adjustments based on the characteristics.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to user interactions with one or more items, such as resources (e.g., webpages, applications, etc.) associated with a content provider and/or paid or unpaid content items displayed within an interface in a resource (e.g., a search engine interface), and determine a price-competitiveness of one or more sales offers presented to users. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include a pricing module 152 configured to analyze path data 162 and determine one or more price-competitiveness metrics 182. Pricing module 152 may identify one or more sales interactions 170 within path data 162. Each sales interaction 170 may represent an instance in which a user was presented with an offer (e.g., via a resource, such as a webpage or application) to purchase an item 172 (e.g., a product and/or service) at an offer price 174. In some implementations, one or more of the sales interactions 170 may be preceded by and/or followed by one or more content interactions 166 in which the user is presented with one or more content items 168. In some implementations, content items 168 may be configured to promote an item being offered for sale.

Pricing module 152 may generate one or more price-competitiveness metrics 182 based on path data 162. Pricing module 152 may receive competitive price data 180 representing prices offered by one or more third party entities (e.g., competitors of a content provider) for one or more items for which offers from the content provider were presented, as reflected in sales interactions 170. Pricing module 152 may determine the price-competitiveness metrics 182 based on a comparison of offer prices 174 reflected in sales interactions 170 with corresponding offer prices of competitors reflected in competitive pricing data 180. Pricing module 152 may generate and/or organize price-competitiveness metrics 182 in one or more of a variety of formats. In various illustrative implementations, pricing module 152 may generate and present price-competitiveness metrics 182 in formats including, but not limited to, an item-level metric 183 (e.g., an indication of the price-competitiveness of a particular item across sales interactions 170), an interaction-level metric 184 (e.g., indications of the price-competitiveness of individual sales interactions 170), a conversion rate report 185 (e.g., a report showing aggregated conversion rates for different levels of a price-competitiveness metric, such as lower price than competitors, approximately the same price as competitors, and higher price than competitors), a user path report 186 (e.g., an illustration of the user paths of path data 162 including an indication of the price-competitiveness of one or more of sales interactions 170), and/or an aggregate business report 187 (e.g., an aggregated price-competitiveness report for an entire business or division of a business). In some implementations, pricing module 152 may generate one or more recommendations for actions that the content provider might consider taking in view of price-competitiveness metrics 182.

In some implementations, system 150 may include an adjustment module 154 configured to identify characteristics related to the likelihood of user price-sensitivity. Adjustment module 154 may generate one or more price-sensitivity characteristics 194 based on path data 162 and price-competitiveness metrics 182, together with characteristic data for users whose interactions are reflected in path data 162. In some implementations, adjustment module 154 may determine a set of price-sensitive characteristics 196 associated with users who tend to be more sensitive to the offer prices (e.g., users less likely to make a purchase if the price is not competitive, which may indicate that the users are price-shopping before purchasing) and/or a set of price-insensitive characteristics 198 associated with users who tend to be less sensitive to offer prices (e.g., users likely to make a purchase regardless of whether or not the price is competitive). In some implementations, adjustment module 154 may adjust one or more bids for content items to be presented to users when the users have one or more of the identified price-sensitivity characteristics 196. In some implementations, adjustment module 154 may dynamically adjust an offer price of offers presented to one or more users when the users have one or more of the identified price-sensitivity characteristics 196.

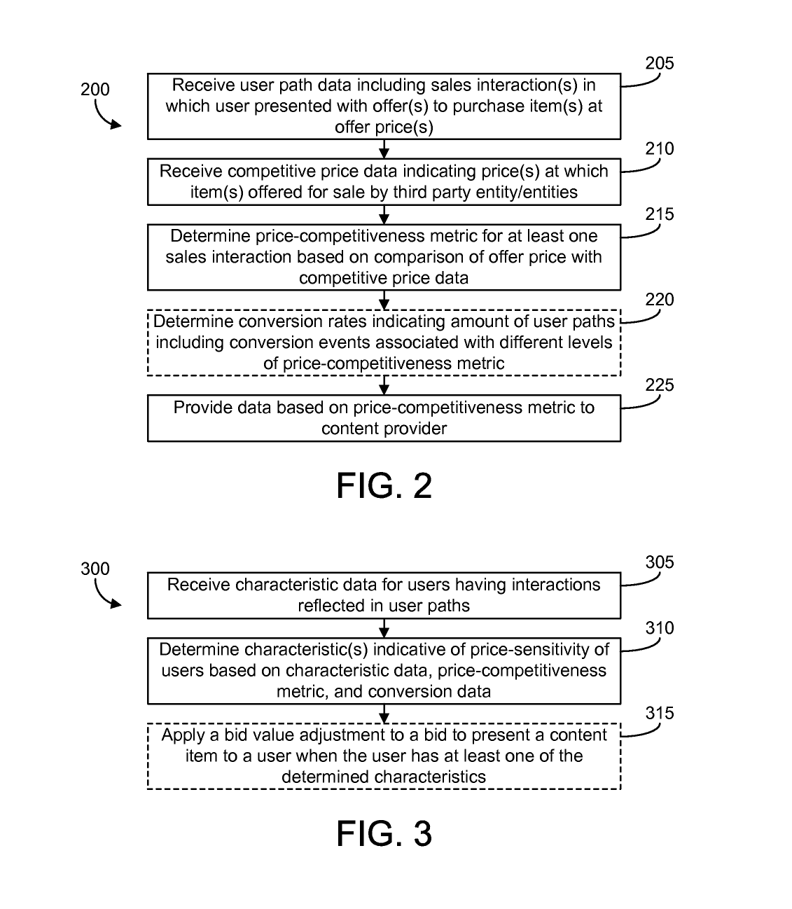

FIG. 2 illustrates a flow diagram of a process 200 for determining the price-competitiveness of one or more item offers presented to users according to an illustrative implementation. Referring to both FIGS. 1 and 2, analysis system 150 may be configured to receive path data 162 indicating one or more previous interactions of users with one or more resources (e.g., webpages, applications, etc.) and/or content items (e.g., paid and/or unpaid content items presented within resources) (205). Path data 162 may include a plurality of user paths, each of which may include one or more sales interactions 170 representing instances in which a user was presented with an offer to purchase an item 172 at an offer price 174. The offers may be presented via one or more resources, such as within webpages (e.g., a webpage of an online sales website) and/or applications (e.g., a shopping application). In some implementations, content providers may provide system 150 with offer prices 174 associated with particular items and/or sales interactions, and analysis system 150 may be configured to associate the offer prices with the interactions (e.g., based on an item identifier, interaction identifier, user device identifier, etc.).

Path data 162 may also include one or more content interactions 166 indicating one or more previous interactions of users with one or more content items 168, such as content items provided within a resource (e.g., within a content interface). In some such implementations, at least some of content interactions 166 may occur prior to sales interactions 170 within the user paths. For instance, a user may be presented with a content item promoting a particular product/service, and the user may click through the content item to reach a webpage through which the user may purchase the item at an offer price. The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). The content campaign may include one or more content items that the content provider wishes to have presented to user devices 104 by content management system 108. In some implementations, some of the content items may have one or more products and/or services associated with the content item. In some implementations, such content items may be designed to promote one or more particular products and/or services. In some implementations, some content items may be configured to promote the content provider, an affiliate of the content provider, a resource (e.g., website) of the content provider, etc. in general, and the products and/or services associated with the content item may be any products and/or services offered for sale through the content provider, affiliate, resource, etc.

Path data 162 may include any type of data from which information about previous interactions of a user with a content campaign can be determined. The interactions may be instances where impressions of a campaign content item have been displayed on the user device of the user, instances where the user clicked through or otherwise selected the content item, instances where the user converted (e.g., purchased a product/service as a direct or indirect result of an interaction with a campaign content item), etc.

In some implementations, path data 162 may include resource visitation data collected by analysis system 150 describing some or all activities leading to a website or other resource of the content provider. Analysis system 150 may collect information relating to a portion of the resource visited/accessed, an identifier associated with the user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit (e.g., a sales interaction 170) or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions (e.g., purchases) resulting from visits/interactions. The full path from a first user interaction to a converting action, such as a purchase or provision of information requested by a content provider, may be referred to as a conversion path. In some implementations, path data 162 may include data relating to multiple conversion paths and/or non-converting paths (e.g., paths ending with an action other than a conversion, such as an abandonment in which the user does not perform a converting action and has no further interaction with resources of the content provider).

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage.

In various implementations, an identifier may be a browser cookie, a unique device identifier (e.g., a serial number), a device fingerprint (e.g., collection of non-private characteristics of the user device), or another type of identifier. The identifier may not include personally identifiable data from which an actual identity of the user can be discerned. Analysis system 150 may be configured to require consent from the user to tie an identifier to path data 162. In some implementations, path data from multiple sources may be utilized even if the path data sets reference different types of identifiers. For example, user paths may be joined by matching one identifier (e.g., browser cookie) with another identifier (e.g., a device identifier) to associate both path data sets as corresponding to a single user.

Analysis system 150 may be configured to receive competitive price data 180 indicating one or more prices at which one or more items offered to users, as reflected in path data 162, were offered for sale by one or more third party entities (e.g., competitors) (210). Competitive price data 180 may identify, for one or more of items 174 reflected in sales interactions 170, prices at which the items were offered by the third parties. In some implementations, the prices identified in competitive price data 180 may be configured to correlate with the circumstances under which one or more offers were presented by the content provider. For instance, for a particular sales interaction 170, the competitive price data 180 used to determine the price-competitiveness of the sales interaction may be pricing data for competitors on a same date and/or around a same time as the sales interaction of the content provider. In some implementations, competitive price data 180 may indicate an individual price offered by each third party. In some implementations, competitive price data 180 may indicate an aggregated competitive price for each product (e.g., an average/mean of the prices offered by the third parties).

In some implementations, competitive price data 180 may be received from a shopping system 130 configured to implement an online shopping environment in which users are presented with offers to purchase items from multiple different entities. Shopping system 130 may store price data 140 in a shopping database 135. Analysis system 150 may transmit a request to shopping system 130 to retrieve and return competitive price data 180 from price data 140, in response to which shopping system 130 may return the requested data. In some implementations, analysis system 150 may transmit an identifier (e.g., a SKU, UPC, product name, and/or other unique item identifier) to shopping system 130, and shopping system 130 may transmit pricing information for the items associated with the identifier. In some implementations, analysis system 150 may additionally or alternatively provide other parameters for the request, such as a requested timeframe for the competitive price data 180. For instance, if path data 162 reflects that a content provider offered an item for sale on a particular date and/or a particular time, analysis system 150 may request competitive price data 180 for the item corresponding with the particular date and/or time, to determine an accurate indication of the price-competitiveness of the offer at the time it was offered.

Analysis system 150 may determine one or more price-competitiveness metrics 182 for one or more of sales interactions 170 based on a comparison of the associated offer prices 174 with corresponding competitive price data 180 (215). In some implementations, system 150 may determine a price-competitiveness metric 182 by determining whether one or more offer prices for one or more sales interactions to which the metric is directed are above or below an aggregated price (e.g., average price) offered by the third parties for the item. If the offer prices of the sales interactions (e.g., the average of the prices) are below the competitive prices offered by the third parties, system 150 may determine the offers to have been competitive. If the offer prices of the sales interactions are above the competitive prices, system 150 may determine the offers to have been uncompetitive. In some implementations, the difference between the competitive prices and offer prices may be compared to one or more thresholds to classify the offer prices. In one illustrative implementation, an offer price may be classified as follows: (1) if the difference between the offer price and the competitive price is less than a first threshold, system 150 may determine the price-competitiveness of the offer to be average (e.g., approximately equal to the competitive prices); (2) if the offer price is less than the competitive price and the difference is greater than the first threshold and less than a second threshold, system 150 may determine the offer to be moderately competitive; (3) if the offer price is less than the competitive price and the difference is greater than both the first and second threshold, system 150 may determine the offer to be highly competitive; (4) if the offer price is greater than the competitive price and the difference is greater than the first threshold and less than a second threshold, system 150 may determine the offer to be moderately uncompetitive; and (5) if the offer price is greater than the competitive price and the difference is greater than both the first and second threshold, system 150 may determine the offer to be highly uncompetitive. It should be appreciated that, in various illustrative implementations, system 150 may be configured to determine the price-competitiveness of offers in a variety of ways, such as by including fewer, additional, or different indicators of the levels of price-competitiveness of the offers, and all such modifications are contemplated within the present disclosure.

In some illustrative implementations, system 150 may be configured to determine one or more item-level metrics 183. An item-level metric 183 may provide an indication of the competitiveness of one or more prices at which a particular item was offered across the user paths reflected in path data 162. In some implementations, item-level metric 183 may be generated by aggregating (e.g., determining a mean and/or median) the offer prices at which the content provider offered the item for sale, as reflected in path data 162, and comparing the aggregated offer price to the corresponding competitive price from competitive price data 180 for the item. In some implementations, system 150 may provide a relative indication of the price-competitiveness of the offers for the item (e.g., on a range from highly competitive to highly uncompetitive).

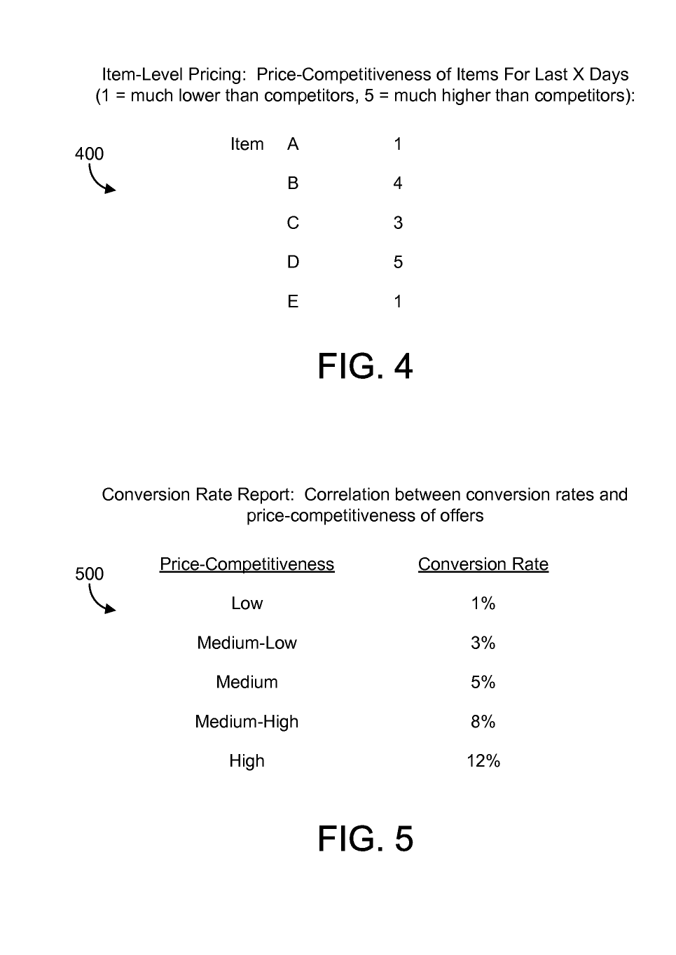

FIG. 4 illustrates a user interface 400 configured to present a plurality of item-level competitiveness metrics according to an illustrative implementation. Interface 400 illustrates a price-competitiveness of five items, A, B, C, D, and E, on a scale of 1 to 5, where a competitiveness of 1 indicates that the content provider's offer price for the item was much lower than the competitive price, and a competitiveness of 5 indicates that the content provider's offer price was much higher than the competitive price. In some implementations, interface 400 may include conversion rates associated with each item category showing a number and/or rate of conversions (e.g., sales) resulting from the sales interactions associated with each item.

Referring again to FIGS. 1 and 2, in some implementations, system 150 may generate interaction-level metrics 184 for one or more of the sales interactions 170. An interaction-level metric 184 may indicate a price-competitiveness of a single sales interaction 170. In some implementations, system 150 may generate an interaction-level metric 184 by comparing an offer price associated with a particular sales interaction with a competitive price associated with the item involved in the interaction. In some implementations, system 150 may compare the offer price to a competitive price associated with a similar set of circumstances, such as a similar timeframe in which the offer was presented to the user.

In some implementations, system 150 may generate a conversion rate report 185 configured to provide an indication of a correlation between the price-competitiveness of offers and the rate at which users presented with the offers performed a converting activity (e.g., purchased the items). In some implementations, system 150 may be configured to determine conversion rates indicating an amount of user paths including conversion events associated with different levels of the one or more price-competitiveness metrics 182 (220). In some implementations, system 150 may generate conversion rate report 185 by grouping interaction-level metrics 184 and results data associated with the sales interactions for the interaction-level metrics 184. In one illustrative implementation, system 150 may group interaction-level metrics 184 and their associated conversion results into five groups: (1) a first group associated with a low price-competitiveness (e.g., where the offer price is higher than the competitive price, and the difference between the offer price and the competitive price exceeds a threshold); (2) a second group associated with a medium-low price-competitiveness (e.g., where the offer price is higher than the competitive price, and the difference between the offer price and the competitive price does not exceed the threshold); (3) a third group associated with a medium price-competitiveness (e.g., where the offer price and competitive price are approximately equal, or within a predetermined difference of one another); (4) a fourth group associated with a medium-high price-competitiveness (e.g., where the offer price is lower than the competitive price, and the difference between the offer price and the competitive price does not exceed the threshold); and (5) a fifth group associated with a high price-competitiveness (e.g., where the offer price is lower than the competitive price, and the difference between the offer price and the competitive price exceeds a threshold). System 150 may calculate an aggregated conversion rate for each group based on the conversion results associated with each group.

FIG. 5 illustrates a user interface 500 configured to provide a conversion rate report according to an illustrative implementation. Interface 500 shows a plurality of price-competitiveness levels, from a low price-competitiveness to a high price-competitiveness. For each level, interface 500 includes an aggregated conversion rate showing a rate at which interactions associated with the particular price-competitiveness level results in conversions (e.g., purchases) by the user. In the illustrated implementation, offers associated with a low price-competitiveness resulted in conversions at a rate of only one percent, while offers associated with a high price-competitiveness resulted in conversions at a rate of twelve percent.

Referring again to FIGS. 1 and 2, in some implementations, system 150 may be configured to generate a user path report 186. User path report 186 may be configured to illustrate (e.g., textually and/or graphically) at least part of one or more user paths reflected in path data 162. In some implementations, user path report 186 may include one or more paths based on a frequency with which the interactions appeared in path data 162. In some implementations, user path report 186 may include one or more paths associated with one or more highest and/or lowest conversion rates. User path report 186 may provide an indication of a price-competitiveness of offer prices 174 for one or more sales interactions 170 of the illustrated user paths. In various implementations, the price-competitiveness may be indicated in a variety of different manners, such as using different colors, shapes, shading, symbols, numbers, etc. to indicate different levels of price-competitiveness. In some implementations, user path report 186 may be provided only internally to an operator of analysis system 150, and may not be provided directly to content providers.

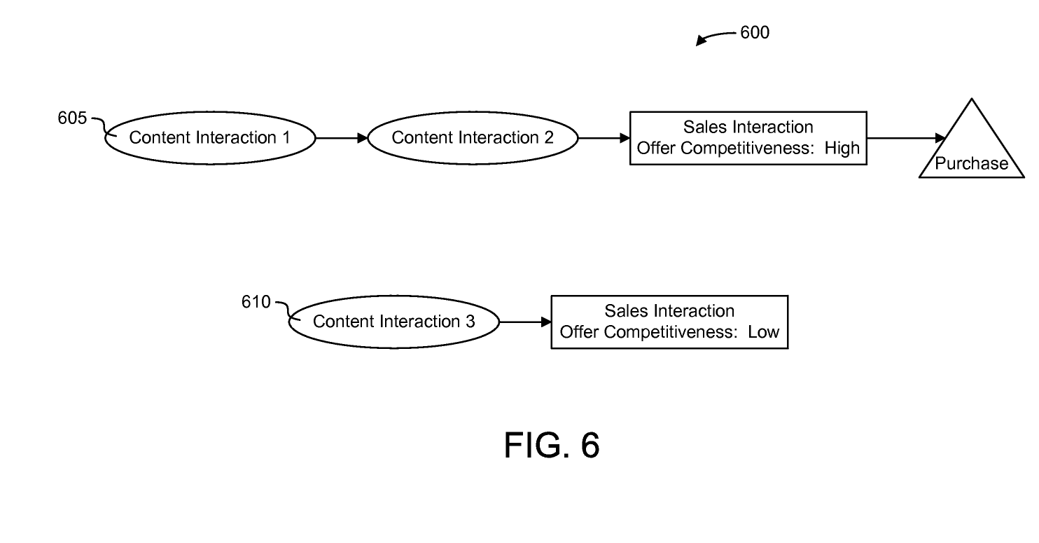

FIG. 6 illustrates a user interface 600 configured to provide a user path report according to an illustrative implementation. Interface 600 illustrates a first path 605 in which a user interacted with two content items, then was presented with an offer to purchase an item at a price that was determined to be highly competitive. The offer resulted in a purchase of the item by the user. Interface 600 also include a second path 610 in which a user interacted with a content item and was presented with an offer to purchase an item at a price that was determined to be uncompetitive. The sales interaction of second path 610 did not result in a purchase. In some implementations, user interface 600 may include one or more indicators to visually illustrate a difference in the competitiveness of the offers associated with paths 605 and 610. In one such illustrative implementation, the sales interaction of path 605 may be depicted in a green color, indicating a highly competitive offer, and the sales interaction of path 610 may be depicted in a red color, indicating an uncompetitive offer.

Referring again to FIGS. 1 and 2, in some implementations, system 150 may be configured to generate an aggregate business report 187. Aggregate business report 187 may provide price-competitiveness information spanning across an entire business, or associated with one or more divisions of a business. In some implementations, aggregate business report 187 may provide price-competitiveness information associated with particular timeframes (e.g., days of weeks, portions of a month, months in the year, etc.), item types, business divisions, content items/campaigns used to promote the items, keywords associated with the campaigns, and/or any other type of information associated with path data 162. In some implementations, system 150 may generate aggregate business report 187 by aggregating interaction-level metrics 184 and/or item-level metrics 183 for the business/division, based on the criteria used in generating the business/division-level metrics (e.g., timeframe). In one such illustrative implementation, system 150 may determine a business-level metric for aggregate business report 187 for items presented on a Tuesday by aggregating interaction-level metrics 184 for all sales interactions associated with the business occurring on a Tuesday. In some implementations, system 150 may also determine aggregated outcome data (e.g., average conversion rates). In some implementations, system 150 may be configured to identify trends and/or generate alerts as one or more business or divisional-level price-competitiveness metrics change over time.

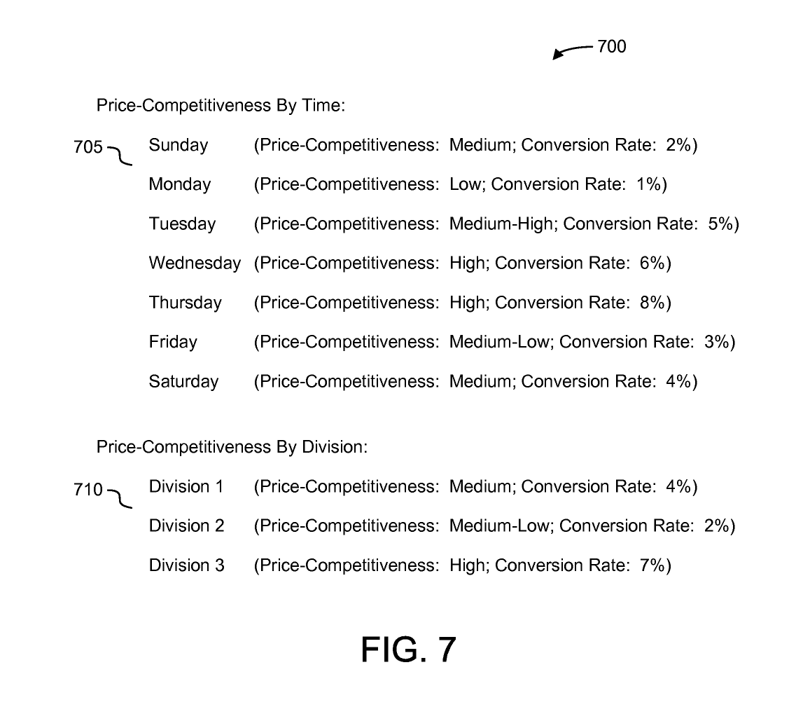

FIG. 7 illustrates a user interface 700 configured to provide an aggregate business report according to an illustrative implementation. Interface 700 includes time-based price-competitiveness information 705 configured to provide an indication of the competitiveness of offers presented on each day of the week. In the illustrated implementation, information 705 also includes an average conversion rate for the sales interactions. Interface 700 also includes division-based price-competitiveness information 710 showing price-competitiveness and conversion rates for offers associated with different business divisions of the business. As noted above, in other implementations, various other types of filtered price-competitiveness data may be presented within interface 700.

Referring again to FIGS. 1 and 2, system 150 may provide data based on price-competitiveness metric(s) 182 to a content provider (225). In some implementations, system 150 may provide the price-competitiveness metrics directly to the content provider (e.g., a relative indication of the price-competitiveness metrics for one or more sales interactions 170, such as low, medium, high, etc.). In some implementations, system 150 may process and/or filter the price-competitiveness information into reports associated with different characteristics (e.g., different levels of price-competitiveness, different items, etc.), and may present the processed information to the content provider. In some implementations, system 150 may provide the price-competitiveness information to an internal operator of system 150, who may present (e.g., discuss) some or all of the price-competitiveness information with the content provider. In some implementations, system 150 may be configured to provide the content provider with one or more recommendations 190 relating to the price-competitiveness information. In one such illustrative implementation, system 150 may be configured to recommend that the content provider adjust a price for one or more items for which a price was found to be uncompetitive and result in a low conversion rate. In another illustrative implementation, system 150 may recommend adjusting one or more bids for displaying content items directed to promoting the items.

In some implementations (e.g., implementations in which analysis system 150 determines and presents information relating to a number of percentage of conversions), analysis system 150 may be configured to determine whether any non-converting paths in path data 162 are actually continued in other user paths, and are not in fact non-converting paths. In some instances, some user paths may be incorrectly interpreted as non-converting paths ending in abandonment events. In some implementations, a user may complete one or more interactions on a first device, such as a mobile device, then move to a second device (e.g., a desktop or laptop computer) to complete additional interactions, the last of which may be a conversion action (e.g., a product purchase). In such implementations, path data 162 may not connect the interactions on the first device with those on the second device, and system 150 may improperly interpret the last interaction on the first device as an abandonment.

In some implementations, system 150 may be configured to determine and remove false positive abandonment events within path data 162. System 150 may determine one or more false positive abandonment events within path data 162. In some implementations, system 150 may utilize an identifier or other signal associated with a path indicating that the user interactions associated with the path are continued on another path associated with another device. Based on the data, system 150 may determine whether a path that appears to be a non-converting path includes a false positive abandonment event, such that the user interactions were continued as reflected in another path associated with another device. System 150 may then remove the paths associated with the false positive abandonment events when determining abandonment numbers/statistics, and may inspect the continued path associated with the other device to determine whether the entire user path ended with a conversion or an abandonment. In some implementations, system 150 may estimate a number of paths associated with cross-device activity (e.g., based on benchmark data estimating cross-device activity amongst a particular vertical, building a model to estimate user-level, cross-device conversions based, for example, on available mobile, tablet, and/or desktop adoption figures, etc.), and may use the estimated numbers to adjust determined conversion data, instead of or in addition to adjustments based on directly linking multiple user paths.

In some implementations, system 150 may be configured to analyze path data 162 and price-competitiveness metrics 182 and determine characteristics that may be indicative of the price-sensitivity of users. FIG. 3 illustrates a flow diagram of a process 300 for determining characteristics indicative of price-sensitivity according to an illustrative implementation. System 150 may receive characteristic data 192 associated with users having interactions reflected in the user paths of path data 162 (305). Characteristic data 192 may include any characteristics associated with a user, such as a device type of the user device used in performing the sales interaction, a geographic region in which the user was located, etc. Characteristic data 192 may be anonymized such that the identity of the underlying user cannot be determined from characteristic data 192. Further, individualized characteristic data 192 is not presented to any content providers.

System 150 may determine one or more characteristics indicative of the price-sensitivity of users based on characteristic data 192, price-competitiveness metric(s) 182, and conversion data associated with path data 162 (310). The conversion data may indicate whether each sales interaction 170 resulted in a purchase or other converting activity. System 150 may be configured to identify one or more sets of common characteristics (e.g., common types of interactions) within path data 162. In some implementations, system 150 may identify the common characteristics using a machine learning process. For each set of common characteristics, system 150 may identify a price-competitiveness metric 182 and a conversion rate of the sales interactions associated with the characteristics, and may determine a price-sensitivity associated with the characteristics. In some implementations, if, for a particular set of characteristics, conversion rates associated with sales interactions are low when the associated offer prices are determined to be uncompetitive, and the conversion rates are higher when the offer prices are determined to be competitive, system 150 may determine the set of characteristics to be price-sensitive characteristics 196 associated with users who are sensitive to the competitiveness of offer prices (e.g., users who are likely to price-shop before purchasing). If for a particular set of characteristics, conversion rates are relatively similar regardless of whether or not the offer prices are competitive, system 150 may determine the set of characteristics to be price-insensitive characteristics 198 associated with users who are not sensitive to the competitiveness of offer prices (e.g., users who are likely to purchase a product without price-shopping).

In some implementations, system 150 may be configured to determine price-sensitivity characteristics 194 based in part on one or more non-price characteristics of the sales interactions. In some such implementations, system 150 may be configured to obtain data relating to the non-price characteristics associated with each sales interaction 170. The non-price characteristics may include, for instance, an availability of the offered product (e.g., whether the product was immediately available or on back-order), one or more offered shipping times and/or prices, one or more offered delivery times (e.g., based on shipping distance), a sales environment (e.g., in-store vs. online orders), etc. One or more non-price characteristics may be considered as covariates in determining the overall price-sensitivity characteristics 194. In one illustrative implementation, system 150 may determine that conversion rates were higher when same-day shipping was available, even if the price was relatively uncompetitive. In such an implementation, system 150 may generate price-sensitivity characteristics 194 indicating that the price-sensitivity of users decreases when same-day shipping is offered.

In some implementations, system 150 may take one or more actions based on the determined price-sensitivity characteristics 194. In some such implementations, system 150 may apply a bid value adjustment to a bid to present a content item to a user when the user has at least one of the determined characteristics (315). In one illustrative implementation, system 150 may increase a bid value for a content item promoting a product to be presented to a user when available characteristics associated with the user match one or more price-insensitive characteristics 198, which may indicate the user may be likely to purchase the product regardless of whether or not the offer price is competitive with prices offered by third parties. In some implementations, system 150 may take into account whether the offer price for the item being promoted has been determined to be price-competitive when determining whether to make bid adjustments. In some implementations, system 150 may consider one or more non-price characteristics of an offer that would be presented to the user if the user clicked through a presented content item in determining a bid adjustment, if any, to be made to the content item bid. In some implementations, system 150 may implement the bid adjustment by transmitting a message to content management system 108 instructing system 108 to modify the bid associated with one or more content items upon determining that a user to whom a content item is to be presented has one or more characteristics matching price-sensitivity characteristics 194.

In some implementations, system 150 may be configured to dynamically determine an offer price for one or more item offers presented to a user. In some such implementations, system 150 may modify an offer price presented to a user (e.g., provide a discount) when one or more characteristics associated with the user and/or the offer match one or more price-sensitivity characteristics 194. In one illustrative implementation, system 150 may determine that a geographic region of the user is associated with users who tend to be price-sensitive. The content provider may desire to increase its market share in this geographic region. In this illustrative implementation, system 150 may provide a discount to the user in an effort to increase market share in the price-sensitive geographic region. In some implementations, analysis system 150 may implement the price adjustment by sending a command to a pricing system to adjust the offer price before the resource presenting the offer is provided to the user device, or may send a communication to the user offering a discount.

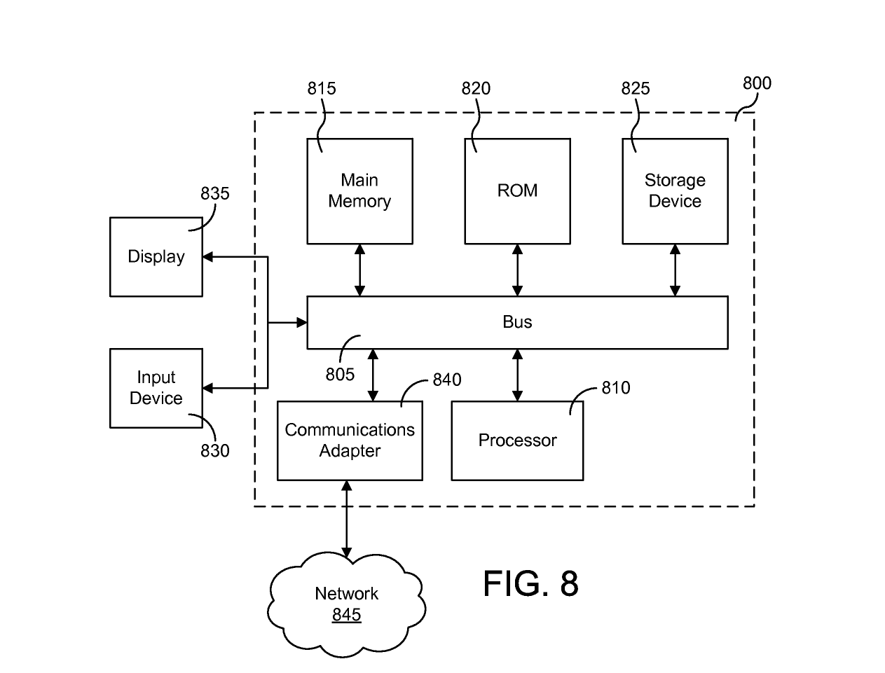

FIG. 8 illustrates a depiction of a computer system 800 that can be used, for example, to implement an illustrative user device 104, an illustrative content management system 108, an illustrative content provider device 106, an illustrative analysis system 150, and/or various other illustrative systems described in the present disclosure. The computing system 800 includes a bus 805 or other communication component for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another implementation, the input device 830 has a touch screen display 835. The input device 830 can include a cursor control, such as a mouse, a trackball, or cursor direction keys, for communicating direction information and command selections to the processor 810 and for controlling cursor movement on the display 835.

In some implementations, the computing system 800 may include a communications adapter 840, such as a networking adapter. Communications adapter 840 may be coupled to bus 805 and may be configured to enable communications with a computing or communications network 845 and/or other computing systems. In various illustrative implementations, any type of networking configuration may be achieved using communications adapter 840, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative implementations, hard-wired circuitry may be used in place of or in combination with software instructions to implement illustrative implementations. Thus, implementations are not limited to any specific combination of hardware circuitry and software.

Although an example processing system has been described in FIG. 8, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized analysis system, user path data representing a plurality of user paths, each of the plurality of user paths comprising one or more content interactions in which a user was presented with a content item featuring information relating to an item available for purchase and one or more sales interactions in which a user was presented with an offer to purchase an item at an offer price, the item being at least one of a product or service offered by a content provider, and one or more of the plurality of user paths comprising conversion events in which the user purchases the item;
receiving, at the analysis system, competitive price data indicating one or more prices at which the item was offered for sale by one or more third party entities;
determining, by the analysis system, a price-competitiveness metric for at least one of the one or more sales interactions based on a comparison of the offer price with the competitive price data; and
providing data based on the price-competitiveness metric to the content provider.

2. The method of claim 1, wherein determining the price-competitiveness metric comprises determining an item-level price-competitiveness metric indicating a competitiveness of the offer price in relation to prices at which the item was offered for sale by the one or more third party entities across the plurality of user paths.

3. The method of claim 1, wherein determining the price-competitiveness metric comprises determining an individual price-competitiveness metric for the at least one sales interaction, and wherein providing data based on the price-competitiveness metric comprises providing an indication of the competitiveness of the offer price to prices at which the item was offered for sale by the one or more third party entities for the at least one sales interaction.

4. The method of claim 3, wherein providing data based on the price-competitiveness metric further comprises providing an indication of whether the at least one sales interaction resulted in a conversion event.

5. The method of claim 1, further comprising determining a plurality of conversion rates indicating an amount of user paths including conversion events associated with different levels of the price-competitiveness metric, wherein providing data based on the price-competitiveness metric comprises providing an indication of the plurality of conversion rates corresponding to the levels of the price-competitiveness metric.

6. The method of claim 1, further comprising:
receiving characteristic data for a plurality of users having interactions reflected in the user paths; and
determining one or more characteristics indicative of price-sensitivity of users based on the characteristic data, the price-competitiveness metric, and conversion data indicative of whether the at least one sales interaction resulted in a conversion event.

7. The method of claim 6, wherein determining the one or more characteristics indicative of price-sensitivity comprises determining a first set of one or more characteristics associated with price-sensitive users based on one or more common characteristics in the characteristic data associated with users for whom conversion events did not result from sales interactions in which the price-competitiveness metric indicates the price was uncompetitive.

8. The method of claim 7, wherein determining the one or more characteristics indicative of price-sensitivity comprises determining a second set of one or more characteristics associated with price-insensitive users based on one or more common characteristics in the characteristic data associated with users for whom conversion events resulted from sales interactions in which the price-competitiveness metric indicates the price was uncompetitive.

9. The method of claim 6, further comprising applying a bid value adjustment to a bid to present a content item to a first user when the first user has at least one of the one or more characteristics.

10. The method of claim 6, further comprising adjusting a first offer price presented to a first user when the first user has at least one of the one or more characteristics.

11. The method of claim 6, further comprising determining the one or more characteristics indicative of price-sensitivity of users based on one or more non-price characteristics of the one or more sales interactions.

12. The method of claim 1, further comprising:
determining one or more false positive abandonment events within the plurality of user paths, wherein each of the one or more false positive abandonment events comprises a last user interaction in a respective one of the plurality of user paths after which the user does not perform further user interactions on a first device, but after which the user performs further interactions on a second device; and
removing the user paths including the false positive abandonment events from consideration when determining one or more conversion metrics associated with the plurality of user paths.

13. A system comprising:
at least one computing device operably coupled to at least one memory and configured to:
receive user path data representing a plurality of user paths, each of the plurality of user paths comprising one or more content interactions in which a user was presented with a content item featuring information relating to an item available for purchase and one or more sales interactions in which a user was presented with an offer to purchase an item at an offer price, the item being at least one of a product or service offered by a content provider, and one or more of the plurality of user paths comprising conversion events in which the user purchases the item;
receive competitive price data indicating one or more prices at which the item was offered for sale by one or more third party entities;
determine a price-competitiveness metric for at least one of the one or more sales interactions based on a comparison of the offer price with the competitive price data; and
provide data based on the price-competitiveness metric to the content provider.

14. The system of claim 13, wherein the price-competitiveness metric comprises an item-level price-competitiveness metric indicating a competitiveness of the offer price in relation to prices at which the item was offered for sale by the one or more third party entities across the plurality of user paths.

15. The system of claim 13, wherein the price-competitiveness metric comprises an individual price-competitiveness metric for the at least one sales interaction, and wherein the data based on the price-competitiveness metric comprises an indication of the competitiveness of the offer price to prices at which the item was offered for sale by the one or more third party entities for the at least one sales interaction.

16. The system of claim 13, wherein the at least one computing device is further configured to determine a plurality of conversion rates indicating an amount of user paths including conversion events associated with different levels of the price-competitiveness metric, and wherein the data based on the price-competitiveness metric comprises an indication of the plurality of conversion rates corresponding to the levels of the price-competitiveness metric.

17. The system of claim 13, wherein the at least one computing device is further configured to:
receive characteristic data for a plurality of users having interactions reflected in the user paths;
determine one or more characteristics indicative of price-sensitivity of users based on the characteristic data, the price-competitiveness metric, and conversion data indicative of whether the at least one sales interaction resulted in a conversion event; and
apply a bid value adjustment to a bid to present a content item to a first user when the user has at least one of the one or more characteristics.

18. The system of claim 17, wherein the at least one computing device is configured to determine at least one of:
a first set of one or more characteristics associated with price-sensitive users based on one or more common characteristics in the characteristic data associated with users for whom conversion events did not result from sales interactions in which the price-competitiveness metric indicates the price was uncompetitive; or
a second set of one or more characteristics associated with price-insensitive users based on one or more common characteristics in the characteristic data associated with users for whom conversion events resulted from sales interactions in which the price-competitiveness metric indicates the price was uncompetitive.

19. One or more computer-readable storage media having instructions stored thereon that, when executed by at least one processor, cause the at least one processor to perform operations comprising:
receiving user path data representing a plurality of user paths, each of the plurality of user paths comprising one or more content interactions in which a user was presented with a content item featuring information relating to an item available for purchase and one or more sales interactions in which a user was presented with an offer to purchase an item at an offer price, the item being at least one of a product or service offered by a content provider, and one or more of the plurality of user paths comprising conversion events in which the user purchases the item;
receiving competitive price data indicating one or more prices at which the item was offered for sale by one or more third party entities;
determining a price-competitiveness metric for at least one of the one or more sales interactions based on a comparison of the offer price with the competitive price data, the price-competitiveness metric providing a quantitative indication of a relative competitiveness of the offer price with respect to one or more competitor offer prices for the item offered by the one or more third party entities; and
providing data based on the price-competitiveness metric to the content provider.

20. The one or more computer-readable storage media of claim 19, further comprising:
receiving characteristic data for a plurality of users having interactions reflected in the user paths;
determining one or more characteristics indicative of price-sensitivity of users based on the characteristic data, the price-competitiveness metric, and conversion data indicative of whether the at least one sales interaction resulted in a conversion event; and
applying a bid value adjustment to a bid to present a content item to a first user when the user has at least one of the one or more characteristics.
